(19) United States
(12) Patent Application Publication
(10) Pub. No.: US 2024/0249636 A1
(43) Pub. Date: Jul. 25, 2024

(54) INTELLIGENT TUTOR SELECTION SYSTEM

(71) Applicant: Connect Education, Inc., Toronto (CA)

(72) Inventor: Marilyn Lizette SOLANO, Toronto (CA)

(21) Appl. No.: 18/421,941

(22) Filed: Jan. 24, 2024

Related U.S. Application Data
(60) Provisional application No. 63/440,851, filed on Jan. 24, 2023.

(51) Int. Cl. G09B 7/04

(52) U.S. Cl. CPC G09B 7/04

(57) ABSTRACT

An intelligent tutor selection system is described. The system allows for parents of young kids to create student profiles for their children to find tutors in a variety of academic subjects. The system determines the tutor most likely to provide lessons resulting in a measured academic outcome for a particular student based on information specified by student demographic information, academic information, academic goals, developmental information, and tutor requirements and historical tutor information including subject information and credential information.

### RELATED APPLICATIONS

This application claims the benefit of U.S. Provisional Application No. 63/440,851 filed on Jan. 24, 2023, the contents of which are incorporated herein by reference in its entirety.

### BACKGROUND

Personalized tutoring fills a niche that cannot be addressed by today's schools alone. Tutoring is becoming more common in schools especially in light of recent rise in blended learning programs. The number of students working with tutors continues to grow. Tutors play a distinct role compared to teachers and parents, placing them in a unique position to support students. Personal relationships are foundational to student success; the more connected a student feels to their tutor, the more trust and respect can be fostered between the two, which is essential for successful learning environment. When a tutor listens and takes time to build a relationship with a student, that tutor is effectively crating a personalized approach, incorporating connections to student's interests, teaching to student's strengths, and minimizing student's weaknesses. However, finding a tutor that connects with the student is much more than finding an expert in a particular subject. Methods are needed to help parents determine and select the right tutor for their child.

Furthermore, a tutor's success is often predicated on their ability to collaborate with parents and teachers, to leverage insight from key adults in students' lives and map a better plan for success and accountability. When tutors communicate with teachers, students experience lasting education success. Accordingly, methods that allow tutoring platforms to integrate with existing learning platforms are needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, system may include one or more processors configured to: render, by at least one processor, an electronic interface of an electronic software application, where the electronic software application is configured to receive a plurality of student profiles and tutor profiles; utilize, by the at least one processor, a machine learning model to predict an academic outcome for at least one student profile of the plurality of student profiles based on at least one parameter associated with the at least one student profile; determine, by the at least one processor, at least one tutor profile attribute associated with the plurality of tutor profiles based at least in part on matching of a minimum tutor score required to achieve the predicted academic outcome; identify at least one tutor profile of the plurality of tutor profiles based on the determined the at least one tutor profile attribute; and update, by the at least one processor, the electronic interface to update a student-tutor match according to the identified the at least one tutor profile likely to result in the predicted academic outcome. Other embodiments of this aspect include corresponding computer systems, apparatus, and computer programs recorded on one or more computer storage devices, each configured to perform the actions of the methods.

Implementations may include one or more of the following features. System where each student profile may include student information having at least one of demographic information, academic information, academic goals, and developmental information; and requirement information may include tutor requirements. System where each tutor profile may include demographic tutor information professional information, subjects tutored, billing rate, and availability information. System where the machine learning model is trained according to a student performance history to correlate a respective academic outcome with a respective at least one parameter associated with each respective historical student profile based on the performance history. System where the at least one parameter may include at least a test performance data. System where the minimum tutor score required to achieve the predicted academic outcome is determining by utilizing a second machine learning model. System where the second machine learning model is trained using data specifying attributes of a plurality of historical tutor profiles associated with a plurality of historical student profiles associated with corresponding historical academic outcomes. System where the at least one tutor profile attribute may include subject information and credential information. System where the one or more processors are further configured to: generate, through the electronic interface of an electronic software application, a digital transaction between the at least one student profile and the at least one tutor profile. System where refining the machine learning model based on comparing the predicted academic outcome to actual academic outcome corresponding to a test performance for the at least one student profile. Implementations of the described techniques may include hardware, a method or process, or a computer tangible medium.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example intelligent tutor selection system, according to an implementation of the disclosure.

FIG. 2 illustrates an example computer-based architecture implementation of the system illustrated in FIG. 1, according to an implementation of the disclosure.

FIG. 3A illustrates an example process for user registration via an email address, according to an implementation of the disclosure.

FIG. 3B illustrates an example process for user registration via Single Sign-On, according to an implementation of the disclosure.

FIG. 3C illustrates an example process for assigning a user role, according to an implementation of the disclosure.

FIG. 3D illustrates an example process for revoking a user role, according to an implementation of the disclosure.

FIG. 3E illustrates an example process for disabling user access, according to an implementation of the disclosure.

FIG. 3F illustrates an example process for re-enabling user access, according to an implementation of the disclosure.

FIG. 3G illustrates an example process for deleting a user account, according to an implementation of the disclosure.

FIG. 3H illustrates an example process for inactivity reminders for Tutor users, according to an implementation of the disclosure.

FIG. 3I illustrates an example process for inactivity reminders for Parent users, according to an implementation of the disclosure.

FIG. 3J illustrates an example process for updating Student information, according to an implementation of the disclosure.

FIG. 4A illustrates an example process for verifying a Tutor user, according to an implementation of the disclosure.

FIG. 4B illustrates an example process for suspending a Tutor user, according to an implementation of the disclosure.

FIG. 4C illustrates an example process for updating Tutor information, according to an implementation of the disclosure.

FIG. 4D illustrates an example process for updating Tutor banking information, according to an implementation of the disclosure.

FIG. 5A illustrates an example inquiry and bidding process, according to an implementation of the disclosure.

FIG. 5B illustrates an example scheduling process, according to an implementation of the disclosure.

FIG. 6A illustrates an example dispute resolution process, according to an implementation of the disclosure.

FIG. 6B illustrates an example workflow for disposure resolution process, according to an implementation of the disclosure.

FIG. 7A illustrates an example payment processing process, according to an implementation of the disclosure.

FIG. 7B illustrates an example tutor payment processing process, according to an implementation of the disclosure.

FIG. 7C illustrates an example refund payment processing to process, according to an implementation of the disclosure.

FIG. 8B illustrates an example support ticket process, according to an implementation of the disclosure.

FIG. 8B illustrates an example workflow for support ticket process, according to an implementation of the disclosure.

FIG. 9 illustrates an example computing system that may be used in implementing various features of embodiments of the disclosed technology.

Described herein are systems and methods for improving methods for identification of tutors based on specific student needs for optimized academic outcome. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

Learning with a human tutor, either in-person or remotely, selected to fit the needs and personality of a particular student, remains the gold standard in education. Currently existing solutions include a plurality of automated, computer-based tutoring systems accessed via a computer system. These systems generally provide educational content of varying difficulty and evaluate student progress by reviewing student-submitted assignments and/or tests. However, presently existing systems fail to provide students with a platform that finds human tutors in accordance with individual student needs and/or requirements. Furthermore, existing solutions fail to integrate tutors with various school or education or learning platforms utilized by the student's learning institution (e.g., Power School).

In accordance with various embodiments, a system and method for providing an intelligent tutor selection is disclosed. The intelligent tutor system was developed after discovering the need for parents or guardians to have an online platform through which they can discover tutors for their children that meet specific needs of the students. For example, parents can enter information about each child (i.e., a student) and identify specific details related to the tutoring assistance they need. These specific details can include school subjects, geographic location, schedule, price, frequency of tutoring sessions. Additionally, because the intelligent tutor system utilizes artificial intelligence engine continuously trained on student and tutor attributes, it can determine tutors best suited to match a student's personality and style, thereby resulting in improved academic performance. The intelligent tutor system is especially valuable for students who wish to integrate the tutor into their present school curriculum.

The intelligent tutor system is also essential for tutors who wish to advertise their services and expand the pools of students they tutor. For example, the system allows parents and/or students to provide feedback and rate individual tutor's performance. Higher-rated tutors will likely be selected by the system more than lower-rated ones.

Presently, parents use online classifieds or ask fellow parents or family for referrals when looking for a tutor-a task that is not only time-consuming but often falling short of finding the tutor that fits their particular needs. Additionally, parents must ensure that the tutors maintain certain credentials and/or certifications, which further complicates the search process. The intelligent tutor system requires that tutors looking to be entered into the pool of those recommended by the system, enter their professional credentials, general qualifications, jurisdiction-specific licensure, background check information, and or other such details. Accordingly, when a tutor is recommended by the system, parents can be assured that the tutor meets the necessary professional and safety requirements.

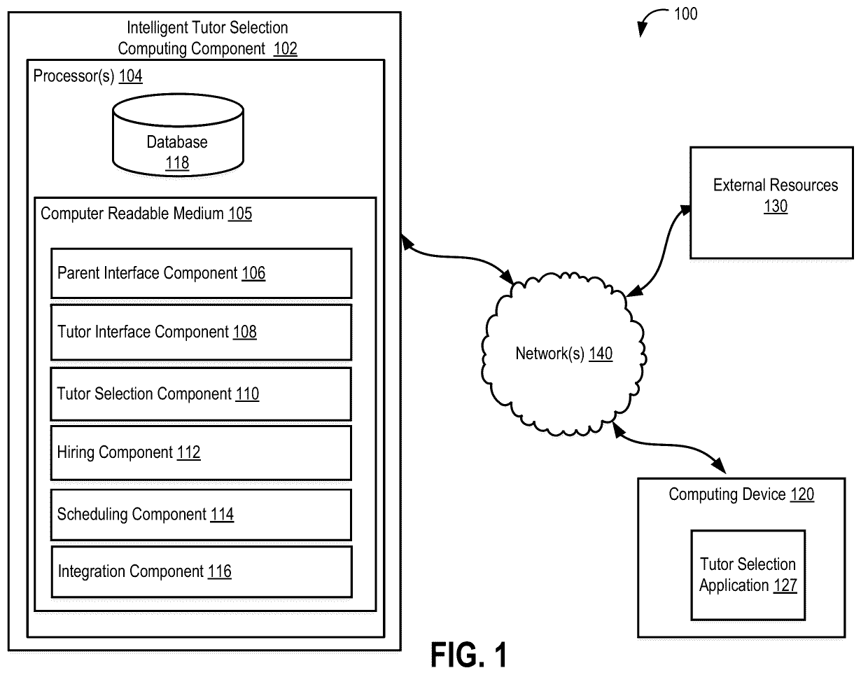

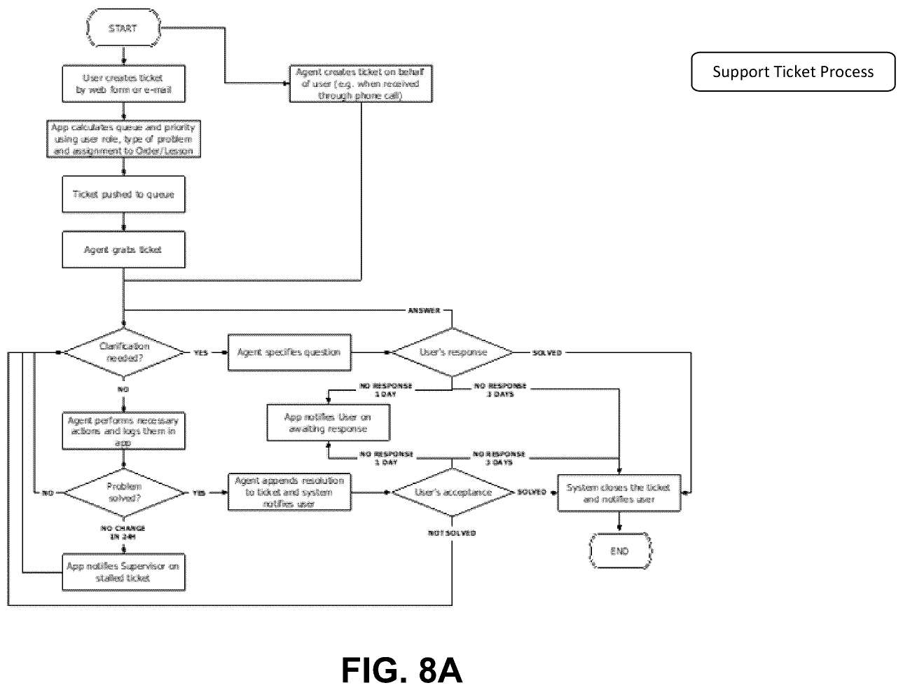

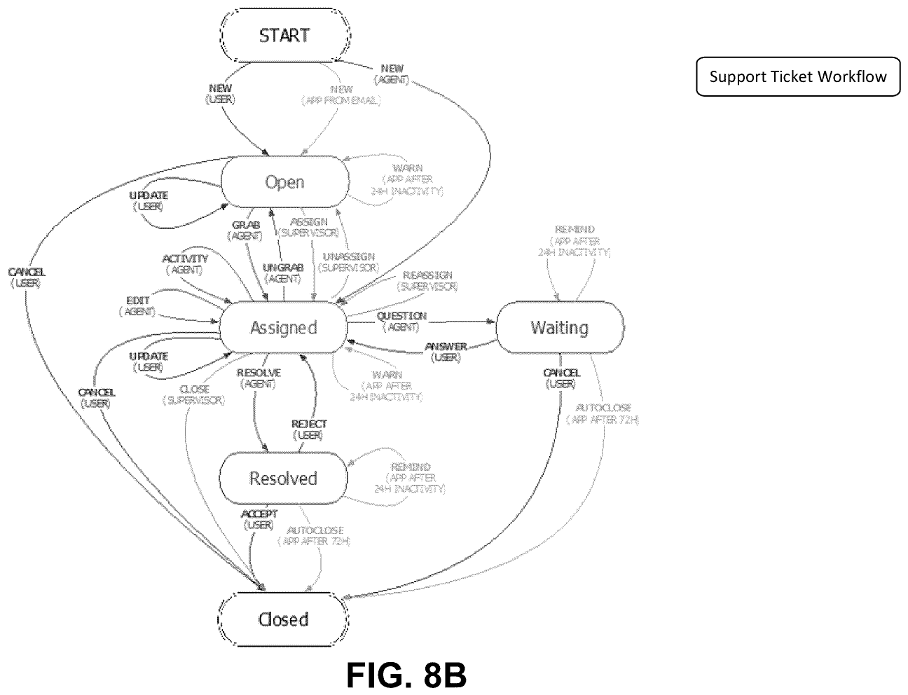

FIGS. 1-9 illustrate systems and methods of determining a tutor for a student based on a measured academic outcome prediction for a particular student using machine learning techniques and database intercommunication.

The following embodiments provide technical solutions s or technical improvements that overcome technical problems, drawbacks or deficiencies in the technical fields involving academic outcome prediction and tutor determination in a robust, accurate and efficient manner to improve the performance and usability of tutor selection programs and applications, among others.

As explained in more detail, below, technical solutions or technical improvements herein include aspects of academic outcome prediction and tutor determination by using machine learning to correlate student profile attributes with tutor profile attributes by coordinating various databases and data sources for more accurate and powerful academic outcome prediction to improve tutor prediction. Based on such technical features, further technical benefits become available to users and operators of these systems and methods.

Moreover, various practical applications of the disclosed technology are also described, which provide further practical benefits to users and operators that are also new and useful improvements in the art.

FIG. 1 illustrates intelligent tutor selection system 100, in accordance with the embodiments disclosed herein. This diagram illustrates an example system 100 that may include a computing component 102 in communication with a network 140. The system 100 may also include one or more external resources 130 and a client computing device 120 that are in communication with network 140. External resources 130 may be located in a different physical or geographical location from the computing component 102.

As illustrated in FIG. 1, computing component or device 102 may be, for example, a server computer, a controller, or any other similar computing component capable of processing data. In the example implementation of FIG. 1, computing component 102 includes a hardware processor 104 configured to execute one or more instructions residing in a machine-readable storage medium 105 comprising one or more computer program components.

Hardware processor 104 may be one or more central processing units (CPUs), semiconductor-based microprocessors, and/or other hardware devices suitable for retrieval and execution of instructions stored in computer readable storage medium 105. Processor 104 may fetch, decode, and execute instructions 106-116, to control processes or operations for determining intelligent tutor selections. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106-116.

As noted above, hardware processor 104 may control processes/operations for facilitating intelligent tutor selection by executing instructions 106-116. Hardware processor 104 may execute instruction 106 to initiate a “parent” interface configured to obtain and manage parent and student information and upload it to database 118. Hardware processor 104 may execute instruction 108 to initiate a “tutor” interface configured to obtain and manage tutor information and upload it to database 118. Hardware processor 104 may execute instruction 110 to determine one or more tutor profiles likely to meet criteria specified by the student information. Hardware processor 104 may execute instruction 112 to initiate an interface configured to hire a tutor selected from the list generated by 110. Hardware processor 104 may execute instruction 114 to initiate an interface configured to provide meeting information for a tutoring session with a tutor selected from the list generated via 110 and hired via 112. Hardware processor 104 may execute instruction 116 to initiate an interface configured to integrate with one or more educational platforms in use by student identified by student information obtained via 106.

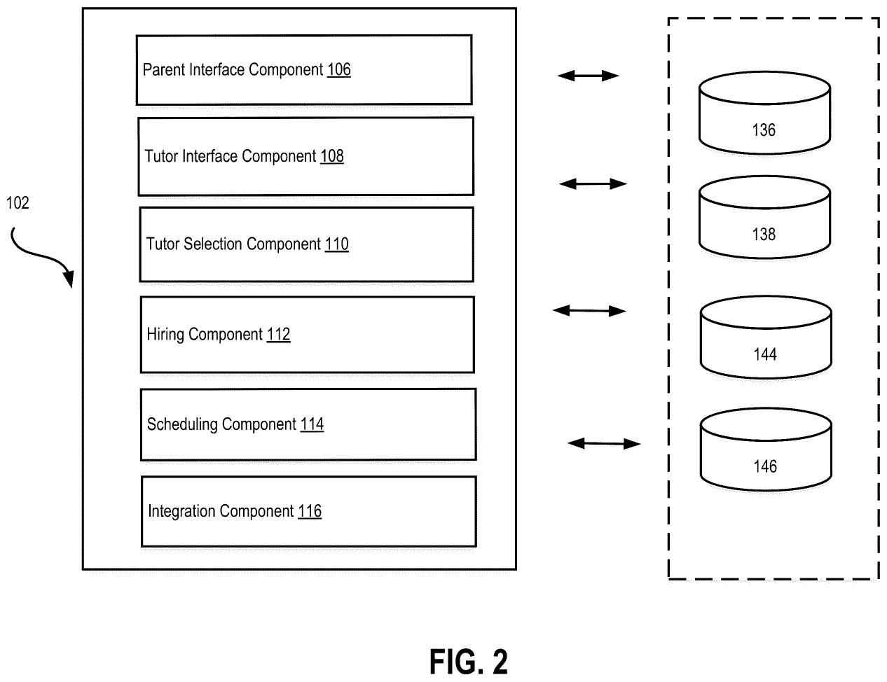

In other embodiments, as illustrated in FIG. 2, the system 100 may receive data from multiple data sources related to student historical profile information, comprising historical demographic information, academic information, academic goals, developmental information, and historical student performance information, including historical academic outcome information (e.g., performance on a test or grade received); as well historical tutor requirements and historical tutor profile information, including subject information and credential information, historical tutor performance information (i.e., positive correlation with historical academic outcome) to facilitate comprehensive and accurate prediction of academic outcome utilized in tutor determination. In some embodiments, the data may include, e.g., student data, tutor data, scheduling data, and performance data, among data. Accordingly, in some embodiments, the system 100 may receive student information, tutor information, scheduling information, and performance information from a student information database 136, the tutor information database 138, the scheduling information database 144, and performance information database 146, the machine learning model may predict a tutor profile that is more likely to result in a measured academic outcome for a student.

Referring bac to FIG. 1, In utilizing system 100, a parent user or a tutor user may open and operate a web application, a software application, a mobile application or the like on the client computing device 120, such as, but not limited to computers, smartphones, tablets, and the like. The computing component 102 may be programmed to perform processing functions of the system and provide instructions to the client computing device 120 for display each of the parent and tutor interfaces discussed herein. For example, parents and tutors may access tutor selection application 127 running on the client computing device 120 and communicating with computing component 102 via network 140.

The following is a description of various user that may be utilized as part of an exemplary form of an embodiment of the intelligent tutor selection system. This is not intended to be a limitation to the system, but rather is provided in order to depict a possible embodiment. It will be understood by one of ordinary skill that variations may be made with regard to this example platform without departing from the scope of the claims.

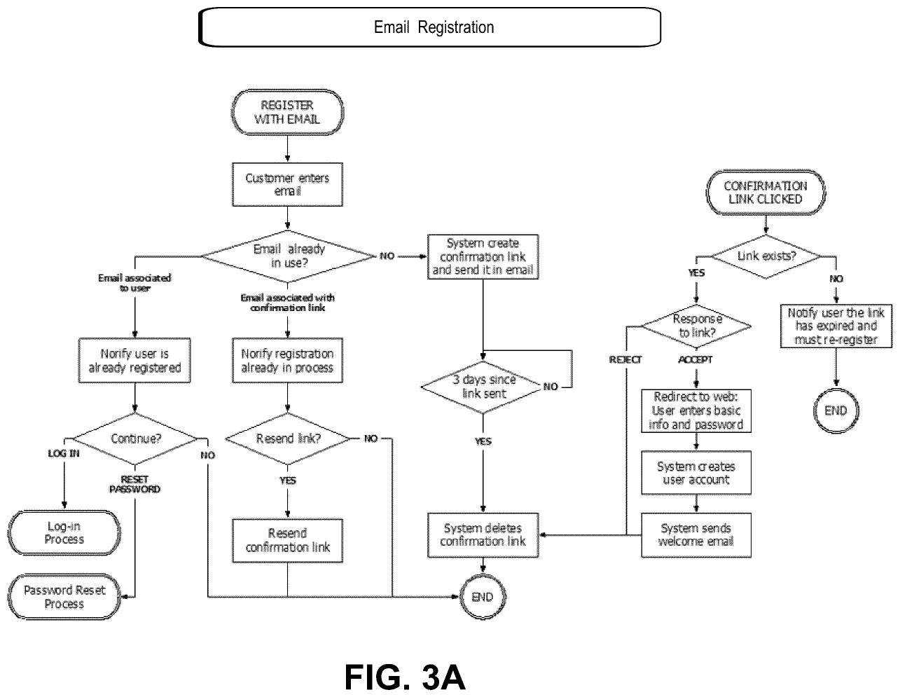

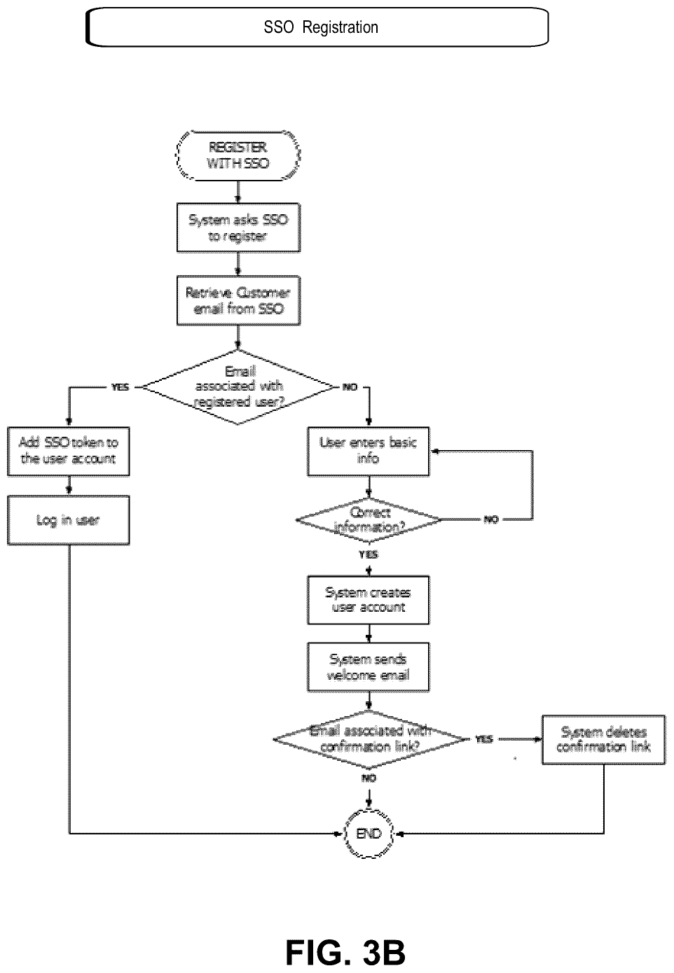

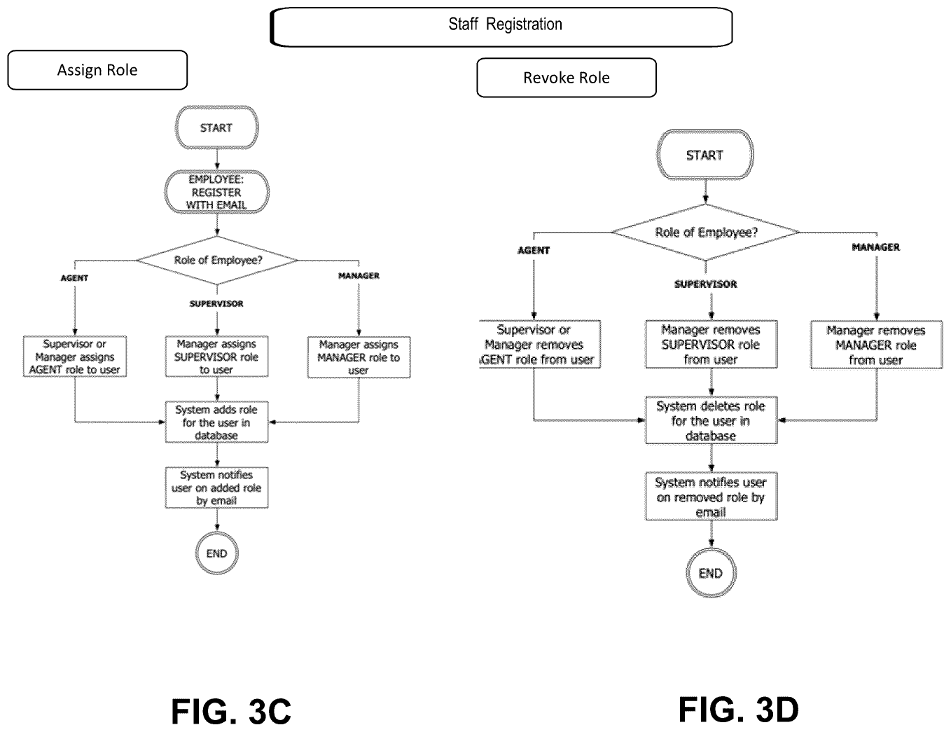

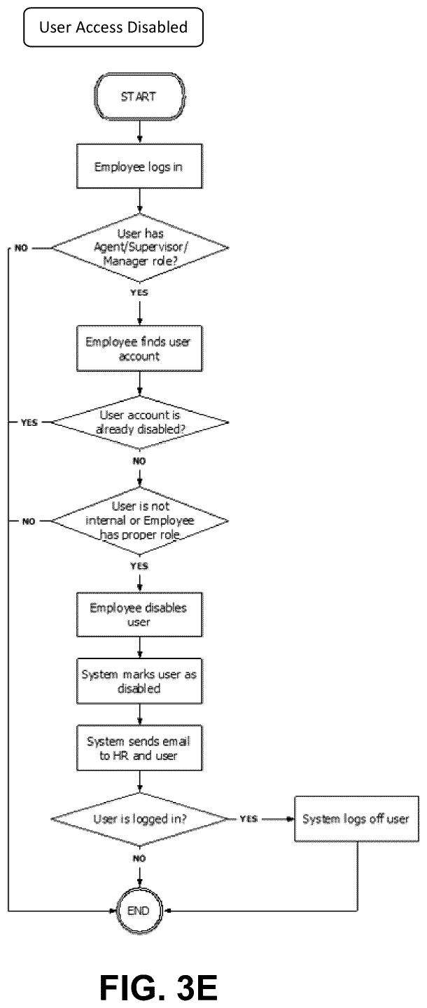

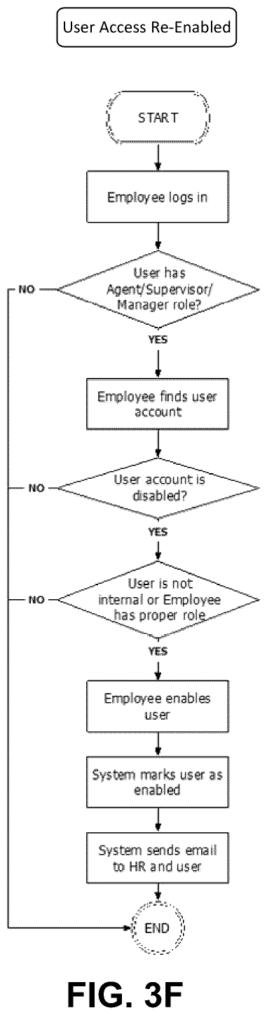

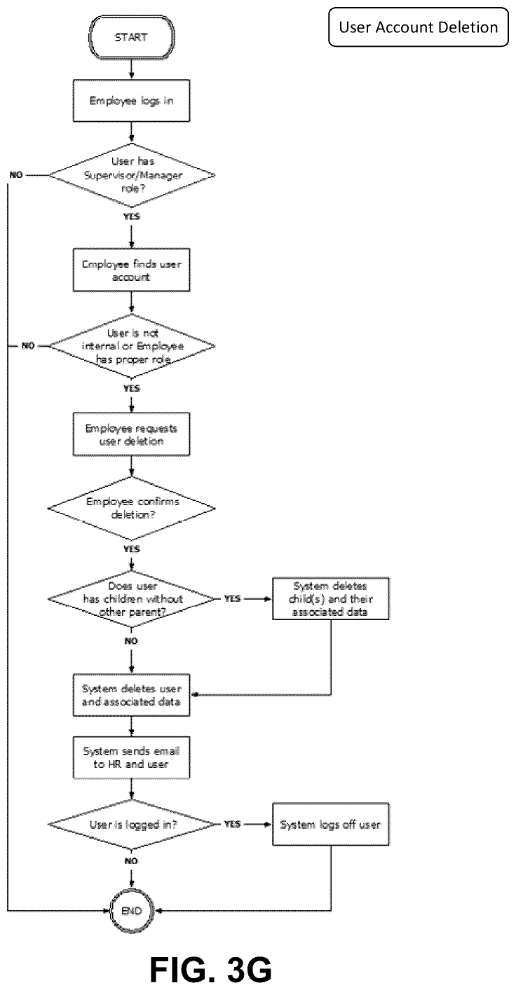

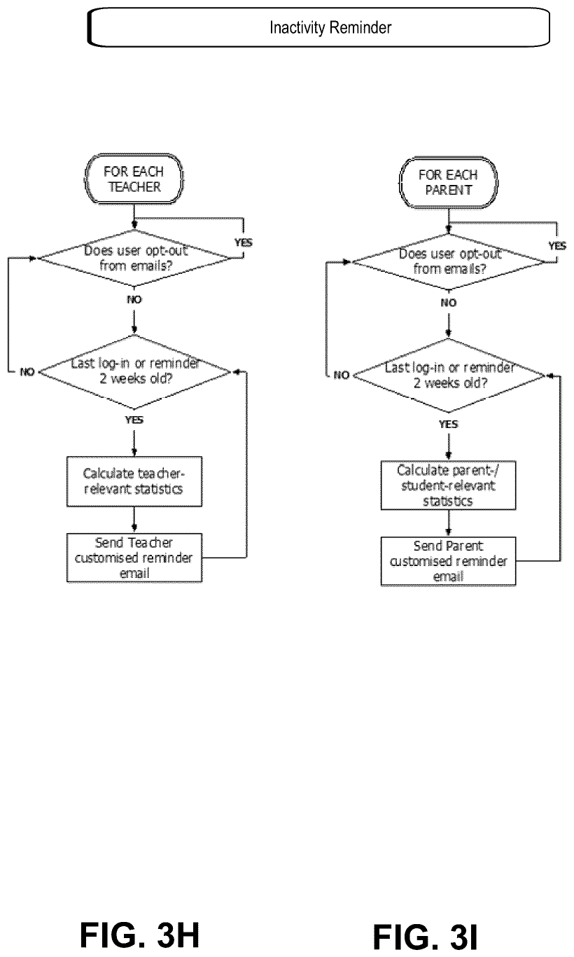

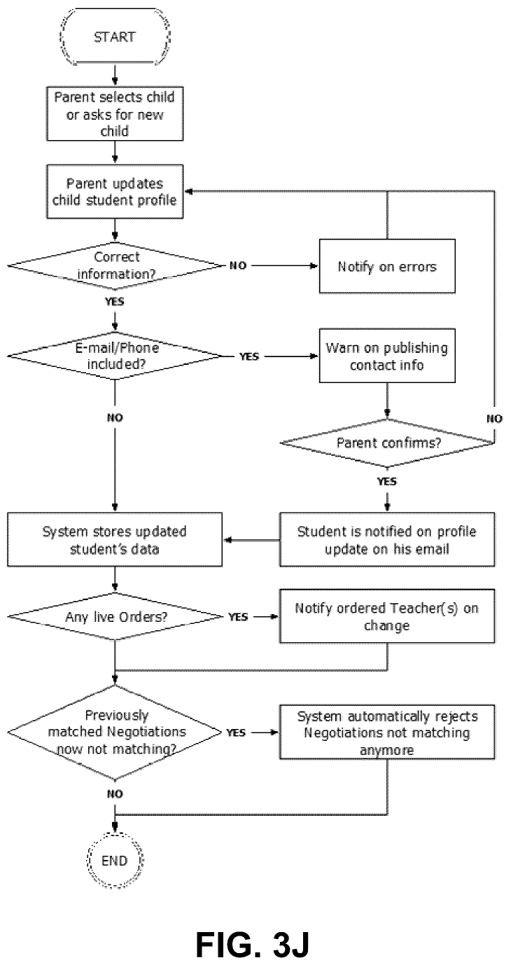

All users (e.g., parents, tutors, users with administrative privileges, corporate users) must register prior to using the system 100. For example, email registration may comprise entering user email with a verification link sent to the user for validating they are a holder of that email account. Process may cancel the registration if email is not confirmed within specific time period. Recipient of the email verification link may have an option to deny the registration (e.g., in the event when the user did not initiate the registration or decided not to complete one), in which case the system 100 will remove all the user data from the database. The registration may be fully automatic and may include CAPTCHA or other means to prevent bots from misusing the process. After email confirmation has been performed, the user must enter required user information and password to complete the registration process. An exemplary workflow for email registration process is illustrated in FIG. 3A.

Alternatively, the system 100 may be configured to provide users with a Single Sign-On (SSO) registration option. SSO registration makes registration easier for user by allowing the user to simply select SSO provider (Gmail, Apple, etc.) and confirm the inter-linking with the system 100. Last step of the process will require the user to enter user biographical and other such similar information.

For example, as illustrated in FIG. 3B, user clicks on SSO registration button. Approves linking to our application after which our application shows form for entering basic user information. Once submitted, the system 100 creates user account from entered data and records a token from SSO to enable log in using SSO Provider. Because Email address is unique per user account, the system will check if email is already associated with registered user (it will then assign a SSO token to the user to enable a login through either email/password or through the SSO Provider). System 100 may also perform a cleanup of any outstanding confirmation links for this email. For example, the user initiate registration by email but then changed their mind and registered using the SSO Provider.

In some embodiments, rather than being used as a global tutor selection system, the system 100 may be utilized on a jurisdictional or regional basis. In this implementation, each instance of the system may be managed by a distinct corporate (business or non-profit) entity. The users (i.e., the corporate employees) will be given a special access to functions of the system 100 available only to such corporate users. A corporate user will behave like a standard user, but will get access to additional application features depending on his/her internal user role. For example, the roles may include an “Agent” (low-level), managed by a “Supervisor” (mid-level), who in turn is managed by “Manager” (top-level). New corporate user may register as described above. Once the user account is created, as illustrated in FIG. 3C, corporate users may be assigned an appropriate role. Supervisor or Manager user may log into, find the corporate user in list of users using their email address and assign a role. The corporate user may be notified by email that the new role has been assigned. Role-limited functionality will be automatically available after corporate user's new login.

In some embodiments, the role of the corporate user may be removed, for example, upon user termination, and for any other reason, as illustrated in FIG. 3D. The corporate user will still be able to log in (unless his login is disabled) but will behave like a standard user. The role can be re-assigned to employee, as illustrated in FIG. 3C. Supervisor or Manager user will log into the application, find employee in list of users using his email and removes his role. Corporate user will be notified by email that the role has been revoked and their role-limited functionality will be automatically disabled.

In some embodiments, any user's access may be disabled (temporarily, note permanent deletion of account is described further below) by a corporate user with requisite access rights. For example, as illustrated in FIG. 3E, any agent can disable regular users, while user with agent account can be disabled only by supervisor or manager and user with supervisor or manager role can be disabled only by manager employee. Agent, Supervisor or Manager logs into the application, find user in list of users using his email and disables him/her. User will be notified by email that his account has been disabled. Copy of the email is sent to HR. Upon disabling, the user will be logged off (if logged in) and further log in attempts will fail.

A disabled user can be re-enabled using user account re-enabling process as illustrated in FIG. 3F. For example, if a user has been disabled, a corporate user with requisite access rights can re-enable their access. Any agent can re-enable regular users, while user with agent account can be enabled only by supervisor or manager and user with supervisor or manager role can be enabled only by manager user. As illustrated in FIG. 3F, Agent, Supervisor or Manager logs into the application, find user in list of users using his email and enables him/her. The user will be notified by email that their account has been re-enabled. Additionally, a copy of the email may be sent to corporate user(s) (e.g., Human Resources in the case user).

Any user account may be permanently deleted (e.g., for a regulatory, legal or any other such reason). For example, a corporate user with requisite access rights can delete atoner user's account. In some embodiments, account deletion rights may be available for supervisors and managers only. User account deletion may be configured to be irreversible and remove all data associated with that user. Upon deleting an account associated with a Parent user, all data associated with his/her children will be deleted but only if the Parent user is the only remaining parent of that child. For example, as illustrated in FIG. 3G, Supervisor or Manager logs into the system 100, find user in list of users using his email and deletes him/her. The user will be notified by email that their account has been deleted. Additionally, a copy of the email may be sent to corporate user(s) (e.g., Human Resources in the case user).

In some embodiments, an automated process may be used to regularly remind users to perform a particular action or keep users abreast of the latest actions taken by other users that may be relevant or require response. For example, a customized email may be generated to specifically tailor content for the user. In other embodiments, the email may be sent to a registered user that has been inactive for a specific period of time. The period of time may be configurable by an administrator user (e.g., ranging from days to weeks). Upon the user logging back into the application or after such a reminder is sent, will cause the inactivity “timer” to be reset. As illustrated in FIG. 3H, for the Tutor user, the email may include statistics, e.g., “You have missed 7 inquiries for your services” or “There are 238 new Students looking for Math Tutor” and so on. Similarly, as illustrated in FIG. 3I, for the Parent user, the email may include statistics, e.g., “There are 23 new Tutors in Ontario area”.

Once the users have registered, they will be using a set of interfaces. The following is a description of various interfaces that may be utilized as part of an exemplary form of an embodiment of the intelligent tutor selection system. This is not intended to be a limitation to the system, but rather is provided in order to depict a possible embodiment. It will be understood by one of ordinary skill that variations may be made with regard to this example platform without departing from the scope of the claims.

The Parent interface may be configured to provide parents seeking to find tutors for their offspring(s) with a way to manage student profiles, find tutors, schedule tutoring sessions, pay for sessions, and other similar functions. Upon creating an account within the system, as described above, Parent users may start using the system. In some embodiments, the Parent interface, for example, may be configured to obtain information related to one or more children the Parent user is looking to find a tutor for. Such information may be entered into a graphical user interface of the intelligent tutor selection application 127 running on the client computing device 120 operated by the Parent user.

The Parent user may create a profile for one or more students. The student profiles created by the Parent user will be linked to the Parent user account. In some embodiments, student information may be obtained from one user (e.g., a Parent) describing another user (e.g., a student). For example, the Parent interface may be configured to obtain information related to student demographic information (e.g., name, age/birth year, gender, student email address, student phone number, geographic location, language(s) for communication, and the like); student academic information (e.g., school information, grade information such as grade point average, subjects completed and currently being studied and the like). The Parent interface may also be configured to obtain information related to student's particular academic goals (e.g., improve in a particular subject area, prepare for an exam, and so on). The Parent interface may be configured to obtain information related to student developmental information (e.g., medical diagnoses, learning disabilities, behavior concerns, any special needs, and so on). In some embodiments, the Parent interface may be configured to obtain information related to tutor requirements (e.g., tutor's qualifications, tutor's availability, type of tutoring such as in-person or virtual, pay rate, special requests, and so on).

In some embodiments, child student user may access their account by virtue of using a student password generated for accessing the linked Parent account. In some embodiments, student age (birth year) may determine whether the student password can be generated. That is, only students over a particular age may be provided with the password. Despite having access, as described above, only the Parent user linked to child student account may update the student information. For example, as illustrated in FIG. 3J, upon updating the student information, the system 100 will be configured to generate reject any inquiries to tutors who no longer match the criteria specified by the student information. Generating tutor profiles matching the student information is described further below.

Student users will not be able to update student information. For example, upon logging in with the student password, the Student user may manage a limited number of functionalities (e.g., rate the tutor, request and accept change of individual lesson, and so on.)

In some embodiments, the Parent interface may be configured to store student information in accordance with one or more privacy guidelines. For example, upon determining the child's age is under a particular age (e.g., as mandated in a particular jurisdiction), the information entered through the Parent interface may be stored in accordance with the guidelines.

All information related to student profiles may be visible to internal staff. Other users have limited access to this information (e.g., inquiring tutors may be able to see only language, education level, health concerns, and birth year).

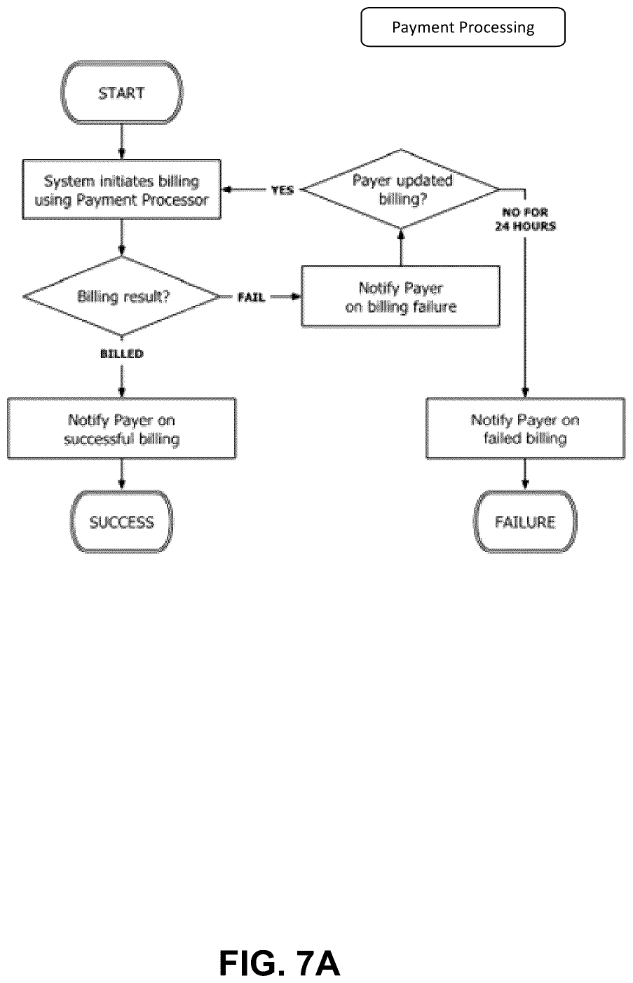

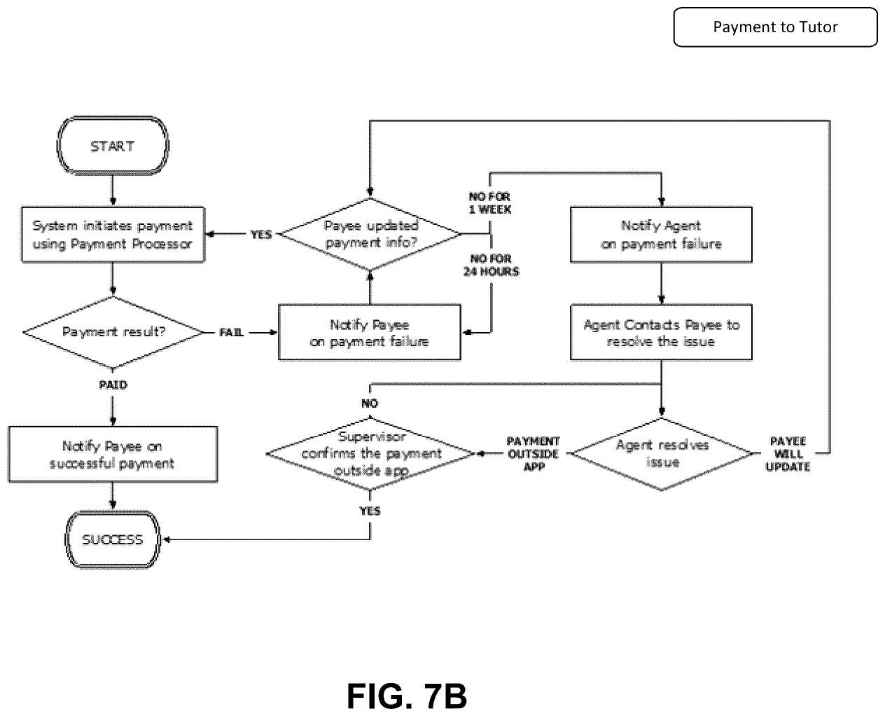

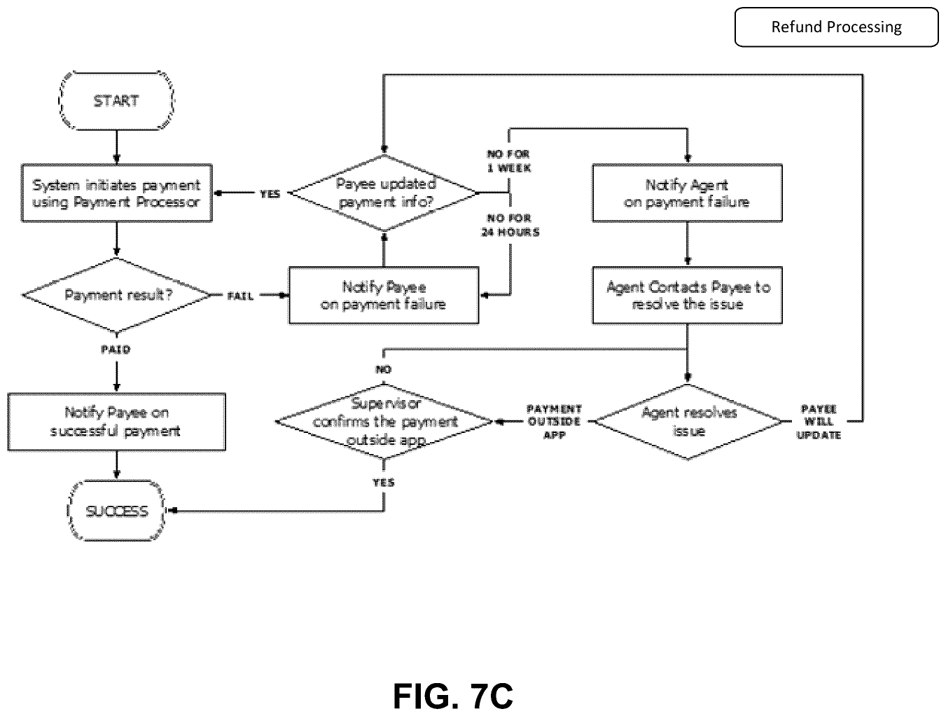

Reimbursing tutors can be a stressful time-consuming process, especially for parents of multiple children and/or children using more than one tutor. It requires maintaining records of tutoring sessions, and any changes or cancellation. To assist parents with reimbursement, the Parent interface may be configured to obtain billing information that will allow payment to automatically be withdrawn from their account in accordance with the agreed upon rate and billing frequency. As illustrated in FIGS. 7A-7C, the system 100 may be configured to store on or more payment methods (e.g., Apple Pay, Visa, Mastercard, American Express, a Bank issued Debit card, ACH payment, and such other similar methods). In some embodiments, the system 100 may be configured to charge a fee (e.g., a percentage of payment) for transaction processing. Further still, the Parent interface may also be configured with a native messaging application for communicating with tutors selected by the system, as will be described in detail herein.

Upon creating an account within the system, as described above, Tutor users may start using the system. In some embodiments, the tutor interface, may be configured to obtain information related to individual Tutor users advertising their tutoring services. Such information may be entered into a graphical user interface of the intelligent tutor selection application 127 running on the client computing device 120 operated by the tutor user.

In other embodiments, Tutor user may create a profile specifying their tutoring services for one or more students. The Tutor interface may be configured to obtain information related to demographic tutor information (e.g., name, age, geographic location and the like); professional information (e.g., education and professional credentials, training received, certifications, background information and/or certifications and the like), subjects tutored, billing rate, and availability information.

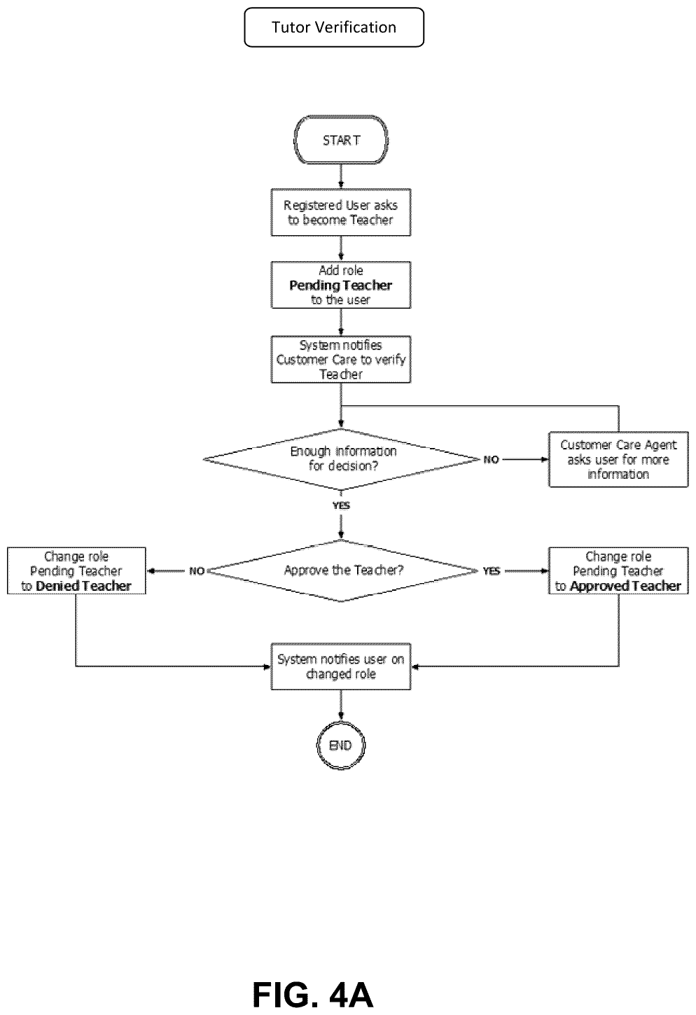

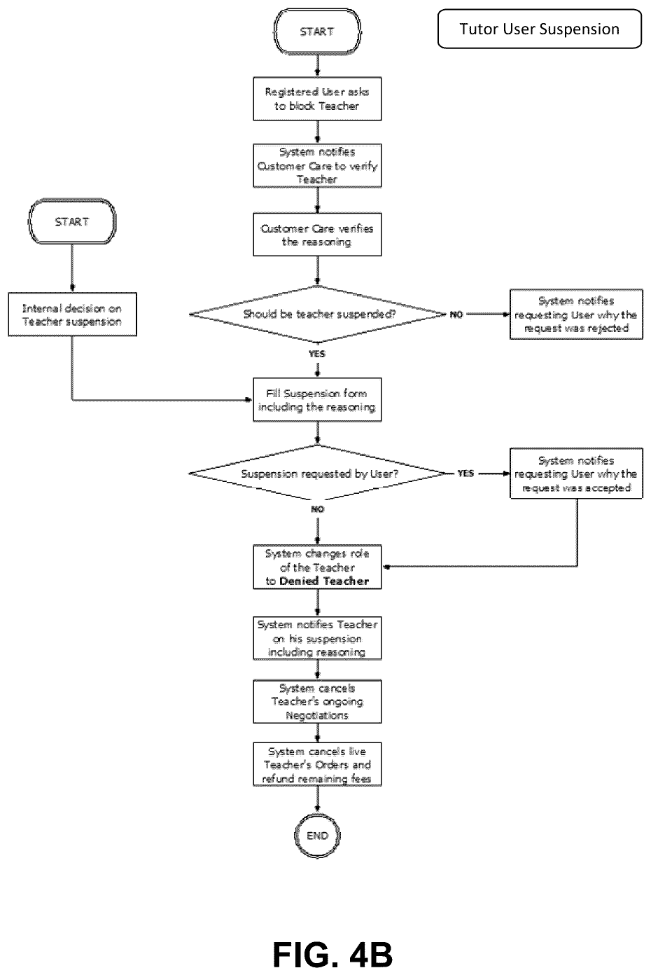

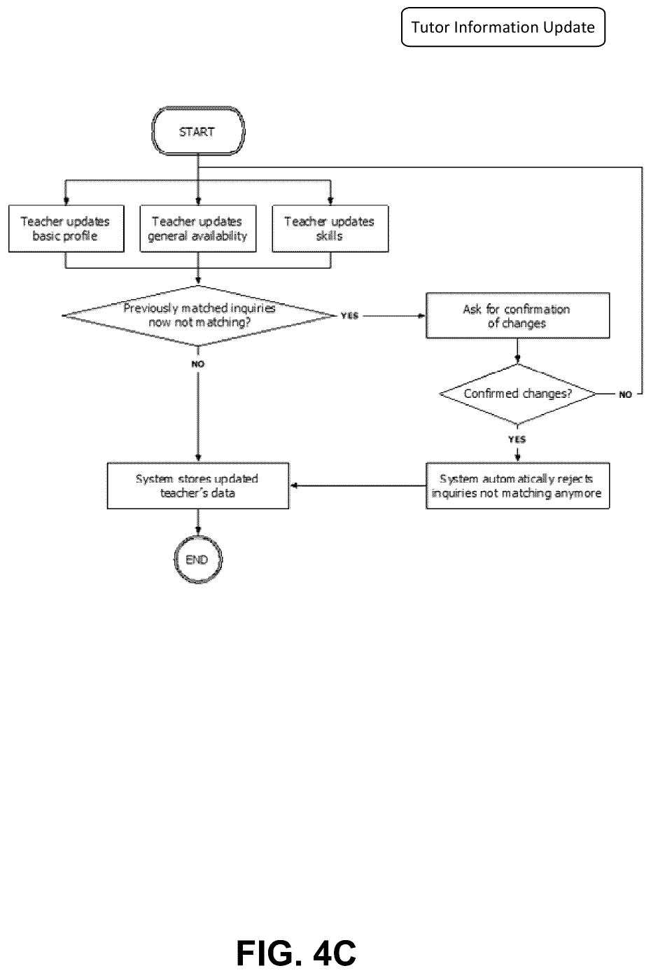

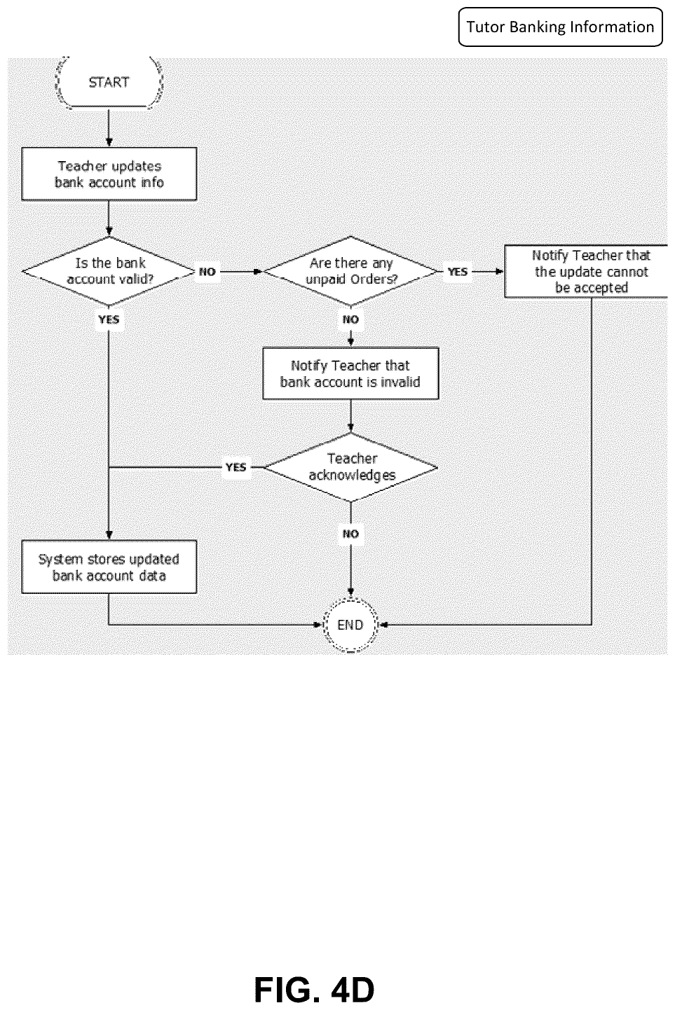

The information entered by the Tutor user may be used to verify the Tutor user. Only after the Tutor user is verifying and the approval from the system 100 is received, the user will actually become visible as Tutor to other users. For example, as illustrated in FIG. 4A, upon receiving the system 100 will add “Pending” role label to the user and will generate a notification transmitted to an administrator/support user to verify the request for verification. Administrator/support user may communicate with Tutor user to provide additional information and, upon review, may accept or reject the request. Upon verifying the Tutor user, that user becomes “approved” Tutor user Alternatively the Pending Tutor role may change to “Denied” if the approval process could not verify the Tutor.

In some embodiments, the approval may be revoked at any time, either by the Tutor user themselves, or by an administrator user described above. The scenarios that will cause the previously issued Tutor user's verification to be revoked may include violating internal system policy, terms and conditions, laws, and other rules. The suspension process allows removal of user's ability to provide educational services on the system 100. The decision to suspend the Tutor user may be decided by the administrator/support user and be based on either internal decision in response to a request from anther user (e.g., Parent user) or request from external entity (law-enforcement, certification authority etc.). As illustrated in FIG. 4B, any Parent/Student user may request to suspend “Approved” Tutor from the system 100. This is limited to only those Tutors, with whom either Parent or Student have communicated directly. Administrator/support user will review the request and either rejects or accepts it using the application with selecting reason for decision and textual explanation (if necessary).

Upon suspension, the “Approved” role will change to “Denied”. Notably, the “Denied” Tutor may be re-enabled upon re-submitting the request for verification described above. Upon suspension, the “Approved” Tutor will be notified. Similarly, the Parent/Student user requesting suspension will also be notified. Upon suspension, the system 100 may cancel any ongoing negotiations between the Tutor and Parent/Student and cancel any scheduled lessons or orders.

Because suspending the Tutor user may damage Tutor's reputation and may affect not only the Tutor but also other users (cancelled lessons for other Students), suspension of a Tutor user account may include a multi-step confirmation in the event the suspension request is based on a rule violation or Parent user or external request.

In some embodiments, as illustrated in FIG. 4C, the Tutor user with “Pending” or “Approved” role may update certain tutor information (e.g., geographic location, languages spoken, email, phone number, current status (retired, active school tutor, active private school tutor etc.), subjects tutored, billing rate, and availability information and/or professional information (e.g., education and professional credentials, training received, certifications, background information, and the like).

Upon receiving the “Approved” role, the Tutor user may not update the information which was used to issue the approval (e.g., name, age, credentials). In some embodiments, the “Approved” Tutor user may contact administrator/support user to request update to the information which was used to issue the approval. The Tutor user may be asked to provide identification and other documents verifying identity and credentials. The information provided by the Tutor user may be fully accessible only to internal administrator/support users or staff users. Other users may have limited access to this information, as described further below.

In some embodiments, the Tutor user with “Pending”, “Approved” role label may update their skills information (topics he/she is able to teach) at any time. Skills may be listed as a triad—a combination of an educational subject, the grade level, and the language in which the Tutor is able to teach the subject. For example, each skill will include: (i) subject (e.g., math, geography, history, and the like), (ii) grade level (elementary, 1^{st} grade, 2^{nd} grade, college, and so on), and (iii) language (i.e., English, Spanish, and so on). The skill information provided by the Tutor user may be fully accessible to all users and may be used for matching inquiries described further below.

In some embodiments, the Tutor user with “Pending” or “Approved” role label may update their general availability information. For example, the Tutor may indicate their availability based on a list of time slots within a particular calendar week, such as Monday 8 AM and 11 AM, Monday 2 PM to 7 PM, Wednesday 2 PM to 7 PM, Friday 1 PM to 5 PM. In some embodiments, the Tutor user may also indicate temporary unavailability (e.g., when planning longer vacation), which will keep scheduled time slots but prevent any incoming inquiries. The skill information provided by the Tutor user may be fully accessible to all users and may be used for matching inquiries described further below.

In some embodiments, the general availability is not used for individual scheduling, so that the Tutor may accept individual lessons to be scheduled outside of his general availability (this applies when scheduling lesson after confirmed contract). Moreover, general availability is also used to calculate Tutor's occupancy for incoming periods (e.g., next week, next month, next three months) as percentage of already scheduled lessons vs total designed working hours.

In some embodiments, the Tutor interface may be configured to obtain and analyze information related to tutor's performance. For example, students and/or parents may leave reviews and provide a rating for a particular tutor that may be viewed by prospective parents and/or students. For example, a Tutor user can be assigned a satisfaction score expressed as a numerical value (e.g., 1, 2, . . . n, where a number may be assigned as low and/or high satisfaction), verbal levels (e.g., very low, low, medium, high, very high, and/or other verbal levels), and/or any other scheme to represent satisfaction. Additionally, Tutor's performance may be evaluated by generating a relative rank based on a cumulative satisfaction score. Further still, Tutor's performance may be evaluated by analyzing the results (e.g., academic improvement) achieved by the tutored students.

In some embodiments, as illustrated in FIG. 4D, the Tutor user with “Pending” “Approved” role label may update their payment information which provides banking information details used to transmit payments to the Tutor for provided lessons. The banking information provided by the Tutor user may be accessible only to internal administrator/support users or staff users. In some embodiments, the banking information provided by the Tutor may be validated prior to being utilized.

In some embodiments, system 100 may be configured as a marketplace for educational services. Upon receiving student profiles using the Parent interface described above, the system 100 may be configured to execute instruction 110 to determine one or more tutor profiles likely to meet criteria provided by the student profile. In other words, the system 100 will determine which tutors best match students' demands. The determination may be made based on information specified by the student demographic information, academic information, academic goals, developmental information, tutor requirements, and other similar data. By virtue of matching the Parent/Student needs with Tutor offerings, the system 100 is able to fill a key need in the educational system marketplace. Additionally, as the number of users (both Tutors and Parents) grows, the accuracy of the matching process will improve resulting in providing users faster and more effective matches.

In some embodiments, the Parent user may specify search criteria, including, student demographic information, including age, academic year, birth year, gender, geographic location, primary language spoken, language(s) for communication, and student developmental information, including medical diagnoses, learning disabilities, behavior concerns, any special needs, and other such information, student academic information, including school information, including school ranking or other evaluation metric data, current grade information, including grade point average, subjects completed and currently being studied, student academic goals, including what level grade point average, test result is being sought, or what subject is the student interested in improving, tutor experience being sought, preferred time of tutoring, and geographic location, and invoke the search. Upon receiving the search command, instruction 110 may determine one or more tutor profiles likely to meet the specified criteria. Additionally, instruction 110 may use information provided by the student profile when determining the one or more tutor profiles. For example, instructions 110 may generate a set of tutor profiles, including tutors that meet one or more requirements. For example, all tutors that assist with sixth-grade algebra in the greater Toronto area and are available on Wednesday nights. The Parent may further specify additional criteria, such as tutor's gender, price, certification requirements, and other similar data.

In some embodiments, the instruction 110 may include, e.g., machine learning models, such as, e.g., one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments, the instruction 110 may, e.g., employ the AI/machine learning techniques to predict a measured academic outcome for a student based on, e.g., student demographic information, student academic information, including academic goals, student developmental information, tutor requirements, historical tutor performance information, including subject proficiency and tutor credential information among others which in turn will be utilized in tutor match determination. In some embodiments, instruction 110 may receive or determine indicators of academic outcome attributes of the student, among other attributes.

In some embodiments, the machine learning model employed by instruction 110 may include, e.g., AI/machine learning techniques, such as those described above, to form parameters from one or more of the attributes, such as, e.g., demographic information, including age, academic year, birth year, gender, geographic location, primary language spoken, language(s) for communication, and student developmental information, including medical diagnoses, learning disabilities, behavior concerns, any special needs, and other such information from the student information database 136, and student academic information, including school information, including school ranking or other evaluation metric data, current grade information, including grade point average, subjects completed and currently being studied, student academic goals, including what level grade point average, test result is being sought, or what subject is the student interested in improving performance information database 146 by correlating each of the attributes with a likelihood of attaining an academic outcome. In some embodiments, using the parameters, the AI/machine learning techniques may predict a level of academic outcome on an individual subject or study area. In some embodiments, the level of outcome may be a scale, such as a numeric scale in a range of between about 1 and about 10, between about 1 and about 5, between about 1 and about 100, or other range. In some embodiments, the level of outcome may include a relative level of outcome, where the instruction 110 may be configured to rank each subject according to a relative outcome level compared to each other study subject.

The determination analysis may be configured to utilize a variety of analytical techniques to analyze collected sets of student demographic information, academic information, academic goals, developmental information, historical student and tutor information, and tutor performance information to generate a single student improvement likelihood indicator.

For example, the analytical techniques may include Bayesian-type statistical analysis to calculate the student improvement likelihood indicator. Additionally, specificity, relevance, confidence and/or weight may be assigned to every one of student demographic information, academic information, academic goals, developmental information, historical student and tutor information, and tutor performance information based on the relevance and relationship between each piece of information to one another. The assignment of these weight factors may be used in determination of user-specific student improvement likelihood results. For example, during a student improvement likelihood determination for a student with a particular behavior concern, a higher weight may be given to historical results of students with similar behavior concerns or tutors with specific training for addressing this type of concern. The selection of these weighting factors may be used to augment the predictive power of the likelihood determination analysis. For example, more established tutors, e.g., those that have been hired more may be associated with a higher credibility factor, while newer, less established tutors may be associated with a relatively lower credibility factor.

The determined student improvement likelihood indicators may be expressed on a sliding scale of percentile values (e.g., 10%, 15%, . . . n, where a percentage may reflect likelihood of student improvement), numerical values (e.g., 1, 2, . . . n, where a number may be assigned as low and/or high), verbal levels (e.g., very low, low, medium, high, very high, and/or other verbal levels), and/or any other scheme to represent an improvement likelihood.

In some embodiments, the system may use machine learning algorithms trained on historical hiring data. The historical hiring data may include historical student demographic information, historical academic information, historical academic goals, historical developmental information, historical tutor information, and historical tutor performance to predict future student performance. For example, historical hiring data may indicate that student with particular demographic and academic parameters experienced more academic improvement when studying with tutors having that particular set of parameters.

In some embodiments, instruction 110 may be configured to apply the predicted academic outcome to determine at least one tutor attribute associated with a tutor profile likely to result in helping the student achieve the predicted academic outcome. For example, the tutor attribute may be selected from tutor information, including tutor demographic information (e.g., name, age, geographic location, and the like), tutor professional information (e.g., education and professional credentials, training received, certifications, tutor background information and/or certifications and the like), subjects tutored, billing rate, and availability information. The system may correlate at least one tutor profile attribute associated with the tutor profile with predicted academic outcome. Alternatively, instruction 110 may be configured to apply employ the AI/machine learning techniques to determine one or more tutor profile attributes based on minimum tutor score calculated to achieve the academic outcome.

For example, in some embodiments, the second machine learning engine may include, e.g., a convolutional neural network (CNN) having multiple convolutional layers to receive a feature map composed of each of the feature vectors, convolutionally weight each element of the feature map using the convolutional layers, and generate an output representing both the tutor profile attribute parameter and the tutor score parameter.

In some embodiments, the system may determine student academic outcome by determining at least one performance likelihood indicators for each tutor within the set based on student demographic information, academic information, academic goals, developmental information, historical student tutor information, tutor performance information, and/or such similar information as may be later determined. The student improvement likelihood indicators may quantify a likelihood of improvement for individual users studying with a particular tutor.

The results may include one or more tutors determined to match student's demands, as described above. For example, the system may effectuate presentation of individual tutor profiles accessed via the Parent interface for review.

In some embodiments, the profiles may be associated with the determined student improvement likelihood indicators. For example, the profiles may be presented in an order such that tutor profiles having the highest indicator scores appearing first. In some embodiments, the profiles may be overlayed on a map to show relative geographic proximity to the student's home.

In some embodiments, the system may provide Parent users with an ability to sort the results by various criteria (e.g., price, distance, age, experience). The Parent user will then be able to select one or multiple Tutors. Upon narrowing down their selection to a set of profiles, the system 100 may contact the Tutors on Parent's behalf (e.g., by sending a notification and/or an email) during an inquiry phase. Parent user may specify a time period for receiving the response from the Tutor.

Next, upon receiving a notification on an inquiry from a Parent, Tutor user can respond with either “Interested” or “Not interested”. In case of “Not interested” response, the system 100 will automatically notify the Parent user after the time period for receiving the response from the Tutor specified by the Parent has expired and completes the injury process.

In case of “interested” response, the Parent user and the Tutor user may engage in a negotiation process (e.g., by exchanging messages) also known as “bidding”. For example, the Tutor user may at any time send an assessment—a list of questions to assess student abilities and needs. In some embodiments, the system may be configured to provide the Tutor user with a set of questions to ask the Parent. In some embodiments, the system may be configured to generate the assessment questions based on information specified by the student demographic information, academic information, academic goals, developmental information, and tutor requirements. For example, students inquiring about introductory reading lessons that are older than nine3 years old may receive questions related to their native language, specific academic information in the subject, additional information related to learning disabilities, and so on. Parent's responses to the assessment questions may be associated with each student profile and stored in database 118 of component 102 (illustrated in FIG. 1) and displayed during the negotiation process with the Tutor user.

In some embodiments, the system may evaluate the assessment responses to generate an assessment score. For example, only responses with an assessment score above a particular threshold may be presented to the tutor.

Once the negotiation process is completed and a mutual agreement is reached, the Tutor user may send a legally binding offer memorializing the details of their agreement (e.g., the subject, the number of hours (“Total Hours”), and the agreed-upon payment for the Total Hours). By accepting the offer, the Parent user forms a legally binding contract with the Tutor user.

The remaining inquiries with other Tutors however will remain open until an Order is successful billed (i.e., the payment is processed successfully). Once the order is successfully billed, the Inquiry process ends. All other biddings with other tutors are cancelled automatically.

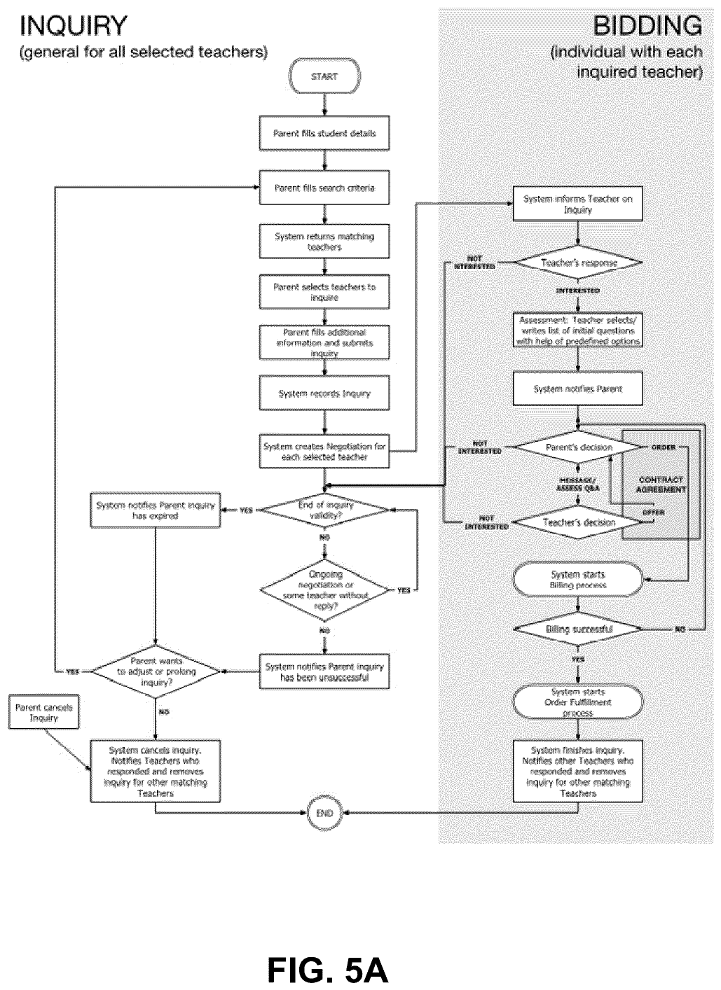

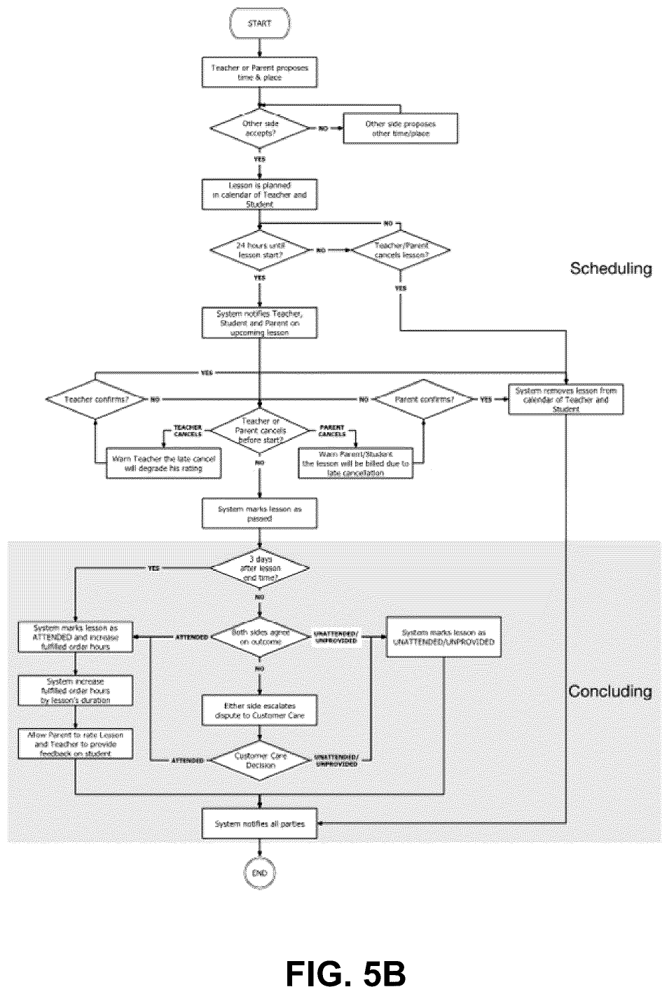

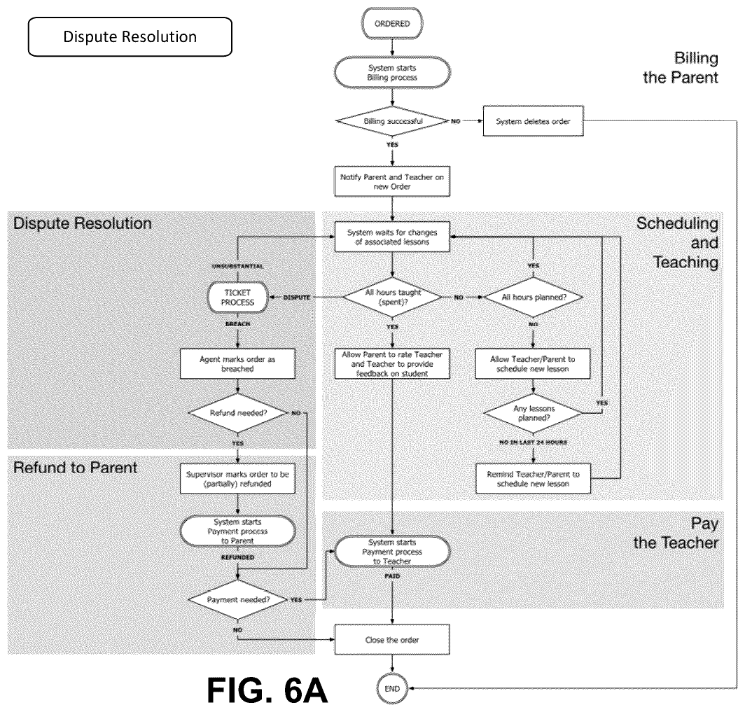

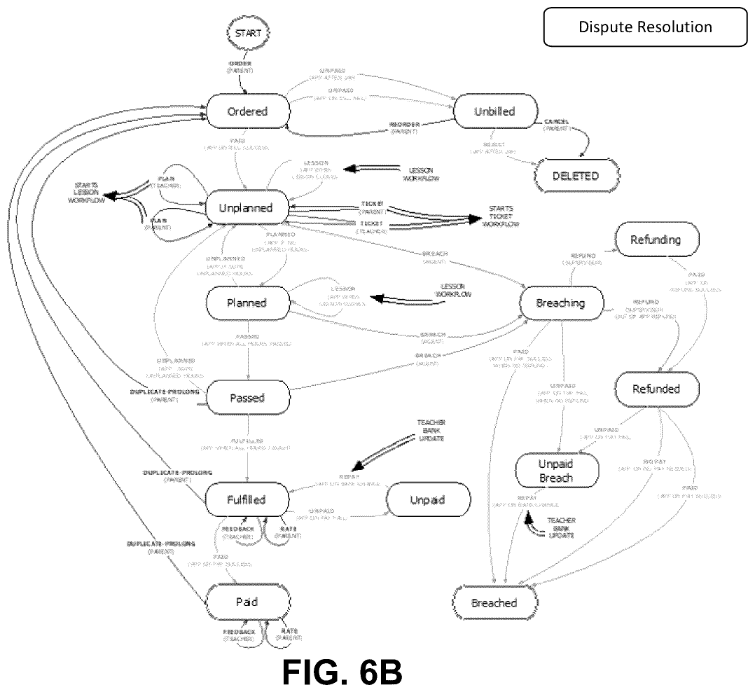

In some embodiments, system 100 may be configured to provide for scheduling of one or more tutoring sessions (i.e., lessons). For example, the system 100 may be configured to allow the Parent users to submit an Order comprising a particular number of hours fulfilled during one or more Lessons (up to remaining ordered hours). Each such created Lesson follows a specific subprocess, as described further below. As illustrated in FIG. 5B, updates to individual Lessons linked to the Order are reflected in the Order itself in the form of aggregates (e.g., number of accepted, performed, planned hours), which are used for determining further flow of the Order itself. In essence, the duration of each taught and accepted lesson is deducted from the number of ordered hours (“Total Hours”) until all ordered hours are fulfilled. As illustrated in FIG. 6B, an Order may be associated with a status (e.g., Ordered, Unbilled, Deleted, Unplanned, Planned, Passed, Fulfilled, Unpaid, Paid, Breached, Breached Unpaid, Breached Refunded, and other similar statuses). For example, once all hours are taught and accepted, the system 100 will change the status to Fulfilled and will automatically transmit payment to the Tutor. If the payment transmission is unsuccessful, the Tutor is notified and able to re-enter their banking information. Order will not close until payment to the Tutor is transmitted successfully.

In some embodiments, an Order for education services may include a number of hours to be taught and to be fulfilled via one or more individual lessons. Each Lesson includes a set of individual attributes including time, place, a respective continuous time slot, if applicable, and lesson status (e.g., lesson provided and attended, lesson not provided, or lesson provided but not attended). For example, if the Lesson was provided and attended, the status may be Attended. Conversely, if the Lesson was provided but not attended, because Student did not show up, the status is Unattended. Finally, if the Lesson did not happen because tutor did not show up, the status is Unprovided. The status determines the fulfillment of the Order. For example, if the Lesson is Attended, then payment associated with the hours for lesson will be deducted from the Total Hours. Either party may provide the status of the Lesson or dispute it. The system 100 may be configured to automatically set the status as “ATTENDED” if the time for the Lesson has passed but neither party specified the status. If the Parent and Tutor cannot agree on the status, they may report the Lesson to the administrator/support user for dispute resolution who will determine final outcome, as explained further below.

The Tutor user may propose the time for the lesson while the Parent user may agree, reject and/or propose a change of the proposed time for the lesson. Once agreed, the lesson becomes planned and is expected to happen. Any party may cancel or change the Lesson within a time period prior to its start (e.g., more 24 hours before its start). If the Parent user cancels a scheduled Lesson less than 24 hours in advance, the Lesson will be cancelled but billed. If Tutor use cancels Lesson less than 24 hours in advance, the Lesson will be cancelled, will not be billed and will affect the rating of that Tutor.

In some embodiments, system 100 may be configured to provide the Parent and Tutor users with a way to report issues with the Lessons for resolution by an administrator/support user. An issue between Parents and Tutors may arise on individual Lesson or Order level. For example, issues could be cause by inability to agree on the time for scheduling Lessons, late cancellations, and so on. Individual Lessons may be disputed within a particular time period (e.g., 3 days) from its scheduled date. If the Lesson is not disputed, the system 100 will automatically close any unresolved lessons after that period.

In some embodiments, the administrator/support user may be an automated agent powered by one or more machine learning algorithms. As illustrated in FIG. 6A, the administrator/support user may analyze information about Order and associated Lessons including related messaging between Parent and Tutor to determine an outcome likely satisfactory to both parties. If unsuccessful, the administrator/support user may determine that the agreement between the parties is breached and make a determination as to apportioning and refunding the payment made by the Parent. In some embodiments, the reimbursement of the payment may require approval from additional users (e.g., supervisor).

In some embodiments, as illustrated in FIG. 6A, upon receiving the approval, the system will automatically refund payment to the Parent (if approved) and payment to Tutor (if not all money has been refunded).

As alluded to earlier, the system 100 may be configured to transmit payment using the payment specified by the Parent user. In some embodiments, a third-party payment processor may be used. For example, the Parent user may be redirected to the third-party payment processor website to enter billing information details and confirm payment. As illustrated in FIG. 7A, the payment may be transferred to a System account upon the Parent user agreeing to purchase the tutoring hours from the Tutor.

Similarly, as illustrated in FIG. 7B, the payment may be transferred from the system 100 account (received from the Parent user) to the financial institution specified by the banking information of the Tutor user upon the fulfillment of the Order.

Upon successful processing of the transaction, the system 100 notifies the Tutor. System is configured to keep the Order open until all payments for all lessons are transferred. For example, the System automatically transfers the payment from system 100 account to the account of the Tutor upon the Lesson receiving the status PROVIDED using the agreed-upon rate per lesson.

In some embodiments, the system 100 may be configured to refund the payment from the system 100 account to the financial institution specified by the banking information of the Parent user upon a finding that the Parent prevailed in a dispute with Tutor user. For example, for already billed but not provided services.

In some embodiments, the system 100 may be configured to provide users with a way to submit inquiries, complaints or requests. For example, these inquiries may be submitted as Support Ticket for resolution by an administrator/support user (“Agent”). Each inquiry will be assigned a Support Ticket number that will be distributed to one or more Agent user. In some embodiments, the system 100 may be configured to provide an interface accessible to Agent users. Upon accessing the system 100, the Agent user may view activities related to Support Ticket, ticket may go back-and-forth between Agent and User until resolved. The Agent is responsible for resolving the Support Ticket, while User is the one approving the resolution which makes the ticket closed.

The Agent assigned to the Support Ticket preforms activities required to resolve the Ticket and creates notes on the steps taken. Whenever the Agent needs a clarification from the User, the Agent may put the Ticket into a “Waiting” state. The Agent will be notified once the User replies.

In some embodiments, the system 100 may be configured to notify the Agent upon expiration of a time period over a threshold for resolving the issue.

When the Agent believes the issue is addressed, the Agent may mark the Support Ticket as “Resolved”. In some embodiments, the system 100 may be configured to notify the user (Parent or Tutor) to approve the resolution. Upon approval, the Support Ticket is closed, and the status is changed to “Closed”. Alternatively, if the resolution is rejected, the Support Ticket remains Open and is returned to the Agent. In some embodiments, a supervisor user may override user approval and enforce closure of the Support Ticket.

In some embodiments, system 100 may operate to improve tutoring capabilities by providing a platform for sharing study media between tutors and students. For example, the system 100 may be configured to allow students to upload study assignments, and other media using client computing devices 120 for storage on the server 102 and to make it accessible by the tutor computing devices 120. In at least this way, sharing the materials between students and tutors enables certain benefits, such as, but not limited to, shared media pages, like mutually created study guides, photos of white board notes during the study sessions, notes, study material and the like.

In some embodiments, system 100 may provide for an online tutoring session platform. For example, the system 100 may determine a location of the tutoring session indicated by the tutor and student. For example, the location of the study session may be a virtual location such as an online audio/video conference. Further, the server 102 may be further programmed to determine location directions of the study session location and send instruction to the student and tutor computing devices for display the location directions to the study session, wherein the location directions include a link to the online audio/video conference.

In some embodiments, system 100 may be include an application programming interface (API) for interfacing with one or more existing education platforms. The API implemented by system 100 may enable system 100 to interact with other software programs associated with one or more existing education platforms and provide access to the services offered by those platforms. The API may include a set of methods, classes, procedures, and/or protocols that allows system 100 to service requests from education platforms (e.g., Power School). In some embodiments, instructions 116 may be configured to provide API components for integrating with one or more outside educational platforms.

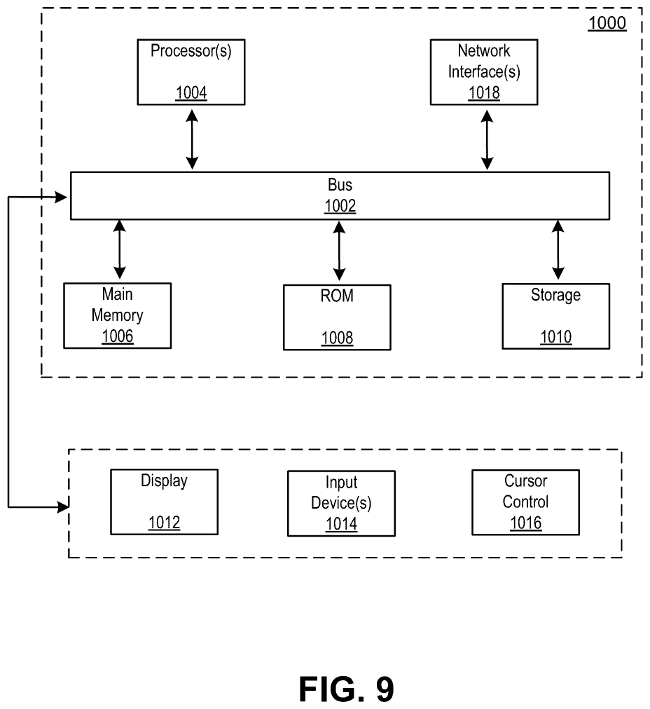

In some embodiments, system 100 may use the API to obtain student performance results from the educational platform. For example, performance results may include grade information, exam information, participation information, materials submitted, teacher feedback, and so on. As alluded to earlier, performance results may be used by the machine learning model to predict academic outcome and determine the tutor, as well as to provide the tutor performance feedback.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 9. Various embodiments are described in terms of this example computing module 1000. After reading this description, it will become apparent to a person skilled in the relevant art how to implement the technology using other logical circuits or architectures.

FIG. 9 illustrates an example computing module 1000, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 1000. After reading this description, it will become apparent to a person skilled in the relevant art how to implement the application using other computing modules or architectures.

Referring now to FIG. 9, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally. The bus 1002 may also be connected to other components such as a display 1012, input devices 1014, or cursor control 1016 to help facilitate interaction and communications between the processor and/or other components of the computing module 1000.

Computing module 1000 might also include one or more memory modules, simply referred to herein as main memory 1006. For example, preferably random-access memory (RAM) or other dynamic memory might be used for storing information and instructions to be executed by processor 1004. Main memory 1006 might also be used for storing temporary variables or other intermediate information during execution of instructions to be executed by processor 1004. Computing module 1000 might likewise include a read only memory (“ROM”) 1008 or other static storage device 1010 coupled to bus 1002 for storing static information and instructions for processor 1004.

Computing module 1000 might also include one or more various forms of information storage devices 1010, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 1010 might include other similar instrumentalities for allowing computer programs or other instructions or data to be loaded into computing module 1000. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 1000.

Computing module 1000 might also include a communications interface or network interface(s) 1018. Communications or network interface(s) interface 1018 might be used to allow software and data to be transferred between computing module 1000 and external devices. Examples of communications interface or network interface(s) 1018 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 1018 might typically be carried on signals, which can be electronic, electromagnetic (which includes optical) or other signals capable of being exchanged by a given communications interface. These signals might be provided to communications interface 1018 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1006, ROM 1008, and storage unit interface 1010. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method, the method comprising:
rendering, by at least one processor, an electronic interface of an electronic software application, wherein the electronic software application is configured to receive a plurality of student profiles and tutor profiles;
utilizing, by the at least one processor, a machine learning model to predict an academic outcome for at least one student profile of the plurality of student profiles based on at least one parameter associated with the at least one student profile;
determining, by the at least one processor, at least one tutor profile attribute associated with the plurality of tutor profiles based at least in part on matching of a minimum tutor score required to achieve the predicted academic outcome;
identifying at least one tutor profile of the plurality of tutor profiles based on the determined the at least one tutor profile attribute; and
updating, by the at least one processor, the electronic interface to update a student-tutor match according to the identified the at least one tutor profile likely to result in the predicted academic outcome.

2. The method of claim 1, wherein each student profile comprises:
student information comprising at least one of demographic information, academic information, academic goals, and developmental information; and
requirement information comprises tutor requirements.

3. The method of claim 1, wherein each tutor profile comprises demographic tutor information professional information, subjects tutored, billing rate, and availability information.

4. The method of claim 1, wherein the machine learning model is trained according to a student performance history to correlate a respective academic outcome with a respective at least one parameter associated with each respective historical student profile based on the performance history.

5. The method of claim 4, wherein the at least one parameter comprises at least a test performance data.

6. The method of claim 5, wherein the minimum tutor score required to achieve the predicted academic outcome is determining by utilizing a second machine learning model.

7. The method of claim 6, wherein the second machine learning model is trained using data specifying attributes of a plurality of historical tutor profiles associated with a plurality of historical student profiles associated with corresponding historical academic outcomes.

8. The method of claim 7, wherein the at least one tutor profile attribute comprises subject information and credential information.

9. The method of claim 1, further comprising generating, through the electronic interface of an electronic software application, a digital transaction between the at least one student profile and the at least one tutor profile.

10. The method of claim 1, wherein refining the machine learning model based on comparing the predicted academic outcome to actual academic outcome corresponding to a test performance for the at least one student profile.

11. A system comprising:
one or more processors configured to:
render, by at least one processor, an electronic interface of an electronic software application, wherein the electronic software application is configured to receive a plurality of student profiles and tutor profiles;
utilize, by the at least one processor, a machine learning model to predict an academic outcome for at least one student profile of the plurality of student profiles based on at least one parameter associated with the at least one student profile;
determine, by the at least one processor, at least one tutor profile attribute associated with the plurality of tutor profiles based at least in part on matching of a minimum tutor score required to achieve the predicted academic outcome;
identify at least one tutor profile of the plurality of tutor profiles based on the determined the at least one tutor profile attribute; and
update, by the at least one processor, the electronic interface to update a student-tutor match according to the identified the at least one tutor profile likely to result in the predicted academic outcome.

12. The system of claim 11, wherein each student profile comprises:
student information comprising at least one of demographic information, academic information, academic goals, and developmental information; and
requirement information comprises tutor requirements.

13. The system of claim 11, wherein each tutor profile comprises demographic tutor information professional information, subjects tutored, billing rate, and availability information.

14. The system of claim 11, wherein the machine learning model is trained according to a student performance history to correlate a respective academic outcome with a respective at least one parameter associated with each respective historical student profile based on the performance history.

15. The system of claim 14, wherein the at least one parameter comprises at least a test performance data.

16. The system of claim 15, wherein the minimum tutor score required to achieve the predicted academic outcome is determining by utilizing a second machine learning model.

17. The system of claim 16, wherein the second machine learning model is trained using data specifying attributes of a plurality of historical tutor profiles associated with a plurality of historical student profiles associated with corresponding historical academic outcomes.

18. The system of claim 17, wherein the at least one tutor profile attribute comprises subject information and credential information.

19. The system of claim 11, wherein the one or more processors are further configured to: generate, through the electronic interface of an electronic software application, a digital transaction between the at least one student profile and the at least one tutor profile.

20. The system of claim 11, wherein refining the machine learning model based on comparing the predicted academic outcome to actual academic outcome corresponding to a test performance for the at least one student profile.
